(19) United States
(12) Patent Application Publication
(10) Pub. No.: US 2007/0005911 A1
(43) Pub. Date: Jan. 4, 2007

(54) Operating System-Based Memory Compression for Embedded Systems

(75) Inventors: Lei Yang, Evanston, IL (US); Haris Lekatsas, Princeton, NJ (US); Robert Dick, Evanston, IL (US); Srimat Chakradhar, Manalapan, NJ (US)

Correspondence Address: NEC LABORATORIES AMERICA, INC., 4 INDEPENDENCE WAY, PRINCETON, NJ, 08540, US

(73) Assignees: NEC LABORATORIES AMERICA, INC., Princeton, NJ (US); NORTHWESTERN UNIVERSITY, Evanston, IL (US)

(21) Appl. No.: 11/427,824

(22) Filed: Jun. 30, 2006

Related U.S. Application Data
(60) Provisional application No. 60/696,397, filed on Jul. 1, 2005.

(51) Int. Cl. G06F 13/00

(52) U.S. Cl. 711/154; 711/202

(57) ABSTRACT

A dynamic memory compression architecture is disclosed which allows applications with working data sets exceeding the physical memory of an embedded system to still execute correctly. The dynamic memory compression architecture provides “on-the-fly” compression and decompression of the working data in a manner which is transparent to the user and which does not require special-purpose hardware. A new compression technique is also herein disclosed which is particularly advantageous when utilized with the above-mentioned dynamic memory compression architecture.

This application claims the benefit of and is a non-provisional of U.S. Provisional Application No. 60/696,397, filed on Jul. 1, 2005, entitled “OPERATING SYSTEM-BASED MEMORY COMPRESSION FOR EMBEDDED SYSTEMS,” the contents of which are incorporated by reference herein.

### STATEMENT REGARDING FEDERALLY SPONSORED R&D

This invention was made in part with support by NSF funding under Grant No. CNS0347942. The U.S. Government may have certain rights in this invention.

### BACKGROUND OF THE INVENTION

The present invention is related to memory compression architectures for embedded systems.

Embedded systems, especially mobile devices, have strict constraints on size, weight, and power consumption. As embedded applications grow increasingly complicated, their working data sets often increase in size, exceeding the original estimates of system memory requirements. Rather than resorting to a costly redesign of the embedded system's hardware, it would be advantageous to provide a software-based solution which allowed the hardware to function as if it had been redesigned without significant changes to the hardware platform.

### SUMMARY OF INVENTION

A dynamic memory compression architecture is disclosed which allows applications with working data sets exceeding the physical memory of an embedded system to still execute correctly. The dynamic memory compression architecture provides “on-the-fly” compression and decompression of the working data in a manner which is transparent to the user and which does not require special-purpose hardware. As memory resource are depleted, pages of data in a main working area of memory are compressed and moved to a compressed area of memory. The compressed area of memory can be dynamically resized as needed: it can remain small when compression is not needed and can grow when the application data grows to significantly exceed the physical memory constraints. In one embodiment, the dynamic memory compression architecture takes advantage of existing swapping mechanisms in the operating system's memory management code to determine which pages of data to compress and when to perform the compression. The compressed area in memory can be implemented by a new block device which acts as a swap area for the virtual memory mechanisms of the operating system. The new block device transparently provides the facilities for compression and for management of the compressed pages in the compressed area of memory to avoid fragmentation.

The disclosed dynamic memory compression architecture is particularly advantageous in low-power diskless embedded systems. It can be readily adapted for different compression techniques and different operating systems with minimal modifications to memory management code. The disclosed architecture advantageously avoids performance degradation for applications capable of running without compression while gaining the capability to run sets of applications that could not be supported without compression.

A new compression technique is also herein disclosed which is particularly advantageous when utilized with the above-mentioned dynamic memory compression architecture. Referred to by the inventors as “pattern-based partial match” compression, the technique explores frequent patterns that occur within each word of memory and takes advantage of the similarities among words by keeping a small two-way hashed associated dictionary. The technique can provide good compression ratios while exhibiting low runtime and memory overhead.

These and other advantages of the invention will be apparent to those of ordinary skill in the art by reference to the following detailed description and the accompanying drawings.

### BRIEF DESCRIPTION OF DRAWINGS

FIG. 1 is an abstract diagram illustrating the operation of the disclosed memory compression architecture in an example embedded system.

FIG. 2 is a diagram illustrating an implementation of a block device in the context of an embodiment of the disclosed memory compression architecture.

FIG. 3 shows an example mapping table.

FIG. 4 illustrates the logical structure of the block device.

FIG. 5 is a flowchart of processing performed by the request handling function of the block device.

FIG. 6 is a flowchart of processing performed by a pattern-based partial match compressor in accordance with a preferred embodiment.

FIG. 7 sets forth an example encoding scheme for pattern-based partial match compression.

### DETAILED DESCRIPTION

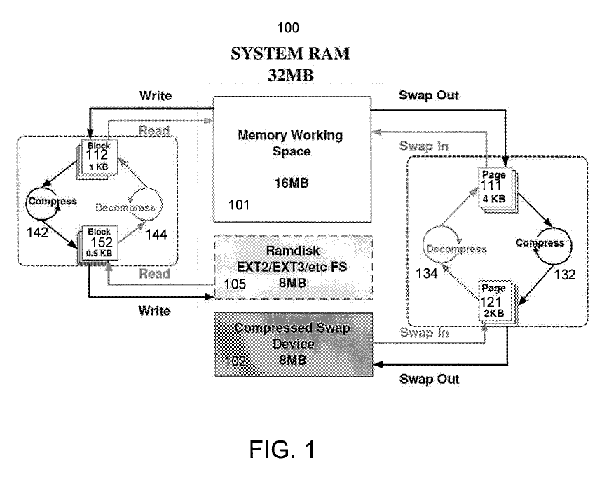

FIG. 1 is an abstract diagram illustrating the operation of the disclosed memory compression architecture in an example embedded system. The embedded system preferably has a memory management unit (MMU) and is preferably diskless, as further discussed herein.

As depicted in FIG. 1, the main memory 100 of the embedded system is divided into a portion 101 containing uncompressed data and code pages, referred to herein as the main memory working area, and a portion 102 containing compressed pages. Consider the scenario where the address space of one or more memory intensive processes increases dramatically and exceeds the size of physical memory. A conventional embedded system would have little alternative but to kill the process if it had no hard disk to which it could swap out pages to provide more memory. As further discussed herein, the operating system of the embedded system is modified to dynamically choose some of the pages 111 in the main memory working area 101, compress the pages at 132, and move the compressed pages 121 to the compressed area 102. When data in a compressed page is later required by an application, the operating system quickly locates that page 121, decompresses it at 134, and copies it back to the main memory working area 101 so that the process can continue to run correctly. The memory compression architecture herein disclosed, thus, allows applications that would normally never run to completion to correctly operate on the embedded system even with limited memory.

Notably, the size of the compressed portion of memory need only increase when physical memory is exceeded. Compression and decompression need only occur for applications with working data sets that do not fit into physical memory. Thus, it is preferable and advantageous for the compressed area to dynamically resize itself based on the size of the working data sets of the running application. Such a dynamic memory compression architecture would have the following properties. Any application, or set of applications, that could possibly have run to completion on the target embedded system without the disclosed technique should suffer no significant performance or energy penalty as a result of using the technique. On the other hand, applications that have working data sets exceeding the size of physical memory may run correctly as a result of the proposed technique. They may suffer some performance and energy consumption penalty when compared with execution on a system with unlimited memory, but, as discussed herein, the use of an appropriate memory compression technique can reduce the effect of such penalties.

Consider an example embedded system with 32 MB of RAM. It is assumed that the embedded system stores its executable code and application data in a compressed filesystem on a RAM disk 105. Without any memory compression, the 32 MB RAM can be divided into a 24 MB main memory working area and an 8 BM RAM disk with filesystem storage. Using the present technique, the same 32 MB RAM can be divided into 16 MB of main memory working area 101, an 8 MB RAM disk 105 holding the compressed filesystem and a compressed swap area 102 which changes in size but in FIG. 1 is shown to be 8 MB in size. Suppose the average memory compression ratio for the swap area is 50%. Then the maximum capacity the swap area can provide is 16 MB. Then, the total memory addressable for the system now becomes 16+16=32 MB. In addition, if the average compression ratio for the RAM disk is 60%, the total filesystem storage available for the system now becomes 13 MB. The system now has virtually 32+13=45 MB RAM for the price of 32 MB RAM. It should be noted that despite how they are depicted in FIG. 1, the compressed area and the uncompressed working area need not be contiguous and need not be of a fixed size. The areas are depicted in FIG. 1 merely to simply explanation. As mentioned herein, the compressed swap area can be dynamically resized in a preferred implementation, based on the sizes of the working data sets of the running applications, and can consist of different chunks of different sizes linked together to address the compressed pages.

It should be noted that there is no need to swap out executable code to the compressed area 102 if the code is already stored in a compressed filesystem 105, as depicted in FIG. 1. A copy of the executable program's text segment is kept in its executable file, e.g., in the compressed RAM disk 105. Paging out an executable's text page has no cost, i.e., it does not need to copied to the compressed area or written back to the executable file (unless the code is self-modifying, which is rare in embedded systems). The executable code can be simply be read back from the RAM disk 105 when needed. The compressed area 102, accordingly, can be reserved and optimized for application data.

The dynamic memory compression architecture can be implemented in the operating system of the embedded system in a number of ways, including through direct modification of kernel memory management code. One advantageous technique for addressing these issues is to take advantage of the existing memory management or swapping code in the operating system.

The design of the dynamic memory compression architecture must address issues such as the selection of pages for compression and determining when to perform compression. These issues can be addressed by taking advantage of the existing kernel swapping operations for providing virtual memory. When the virtual memory paging system selects candidate data elements to swap out, typical operating systems usually adopt some sort of least-recently-used (LRU) algorithm to choose the oldest page in the process. In the Linux kernel, swapping is scheduled when the kernel thread kswapd detects that the system is low on memory, either when the number of free page frames fall below a predetermined threshold or when a memory request cannot be satisfied. Swap areas are typically implemented as disk partitions or files within a filesystem on a hard disk. Rather than using a conventional swap area, in particular since many embedded systems do not have a hard disk, the present dynamic memory compression architecture can provide a new block device in memory that can act as the compressed swap area. The new block device can act as a holder for the compressed area while transparently performing the necessary compression and decompression. This approach is particularly advantageous with an operating system such as Linux where the block device can be readily implemented using a loadable module for the Linux kernel-without any necessary modification to the rest of the Linux kernel.

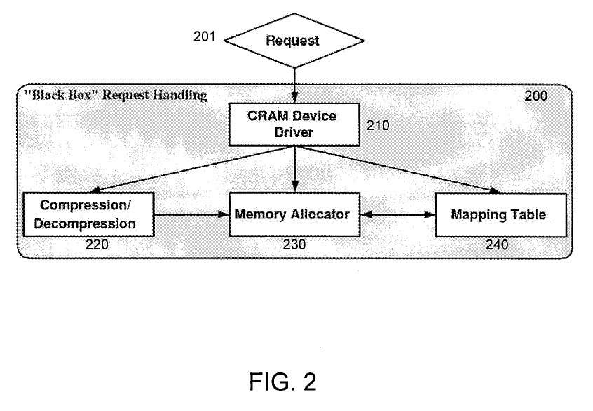

FIG. 2 is a diagram illustrating the architecture of an implementation of the new block device. The block device 200 provides a function in a device driver 210 that handles requests 201. The block device 200 does not need to expose read and write functionality directly to the layer above and can act as a “black box” to the rest of the system. Compression, decompression, and memory management can be handed “on-the-fly” within the device. The block device 200 includes a compression/decompression module 220, a memory allocator 230, and a mapping table 240. The compression/decompression module 220 is responsible for compressing a page/block which is written to the block device or decompressing a page/block which is read from the device. The memory allocator 230 is responsible for allocating the memory for a compressed page or locating a compressed page with an appropriate index. It is also responsible for managing the mapping table according to different operations and merging free slots whenever possible. The detailed operation of each part of the block device implementation are discussed in further detail herein.

Compression. The compression/decompression module 220 advantageously is not limited to a specific compression algorithm and can be implemented in a manner that allows different compression algorithms to be tried. Compressing and decompressing pages and moving them between the main working area and the compressed area consumes time and energy. The compression algorithm used in the embedded system should have excellent performance and energy consumption, as well as an acceptable compression ratio. The compression ratio must be low enough to substantially increase the amount of perceived memory, thereby enabling new applications to run or allowing the amount of physical memory in the embedded system to be reduced while preserving functionality. Trade-offs exist between compression speed and compression ratio. Slower compression algorithms usually have lower compression ratios, while faster compression algorithms typically give higher compression ratios. In addition, slower compression algorithms, which generate smaller-sized compressed pages, can have shorter latencies to move the page out to the compressed area. Based on the inventors' experiments, the known LZO (Lempel-Ziv-Oberhumer) block compression algorithm appears to be a good choice for dynamic data compression in low-power embedded systems due to its all-around performance: it achieves a low compression ratio, low working memory requirements, fast compression, and fast decompression. LZRW1 (Lempel-Ziv-Ross Williams 1) also appears to be a reasonable choice and RLE (run-length encoding) has a very good memory overhead. Nevertheless, these existing compression schemes do not fully exploit the regularities of in-RAM data. Accordingly, the inventors have devised another advantageous compression technique which is described in further detail below.

Memory Allocator. The memory allocator 230 is responsible for efficiently organizing the compressed swap area to enable fast compressed page access and efficiently packing memory. Compression transforms the easy problem of finding a free page in an array of uniform-sized pages into the harder problem of finding an arbitrary-sized range of free bytes in an array of bytes.

Nevertheless, the problem of allocating a compressed-size page in the compressed area, mapping between the virtually uncompressed pages and the actual location of the data in the compressed area, and maintaining a list of free chunks, is similar to the known kernel memory allocation (KMA) problem. In a virtual memory system, pages that are logically contiguous in a process address space need not be physically adjacent in memory. The memory management subsystem typically maintains mappings between the logical (virtual) pages of a process and the actual location of the data in physical memory. As a result, it can satisfy a request for a block of logically contiguous memory by allocating several physically non-contiguous pages. The kernel then maintains a liked list of free pages. When a process requires additional pages, the kernel can remove them from the free list; when the pages are released, the kernel can return them to the free list. The physical location of the pages is unimportant. There are a wide range of known kernel memory allocation techniques, including Resource Map Allocator, Simple Power-of-Two Freelists, the McKusick-Karels Allocator (see M. K. McKusick and M. J. Karels, “Design of a General-Purpose Memory Allocator for the 4.3 BSD UNIX Kernel,” USENIX Technical Conference Proceedings, pp. 295-303 (June 1988)), the Buddy System (J. L. Peterson and T. A. Norman, “Buddy Systems,” Communications of the ACM, Vol. 20, No. 6, pp. 421-31 (June 1977)), and the Lazy Buddy Algorithm (see T. P. Lee and R. E. Barkley, “A Watermark-Based Lazy Buddy System for Kernel Memory Allocation,” USINX Technical Conference Proceedings, pp. 1-13 (June 1989)). The criterion for evaluating a kernel memory allocator usually includes its ability to minimize memory waste and its allocation speed and, for the present problem of interest, energy consumption. There is a tradeoff between quality and performance, i.e., techniques with excellent memory utilization achieve it at the cost of allocation speed and energy consumption.

Based on the inventors' evaluation of the performance of the above-mentioned allocation techniques, the inventors have found the resource map allocator to be a good choice. A resource map is typically represented by a set of pairs, a base starting address for the memory pool and a size of the pool of memory. As memory is allocated, the total memory becomes fragmented, and a map entry is created for each contiguous free area of memory. The entries can be sorted to make it easier to coalesce adjacent free regions. Although a resource map allocator requires the most time when the chunk size is smaller than 16 KB, its execution time is as good as, if not better than, the other allocators when the block size is larger than 16 KB. In addition, the resource map requires the least memory from the kernel. This implies that the resource map allocator is probably a good choice when the chunk size is larger than 16 KB. In the case where the embedded system memory size is less than or equal to 16 KB, faster allocators with better memory usage ratios may be considered, e.g., the McKusizk-Karels Allocator.

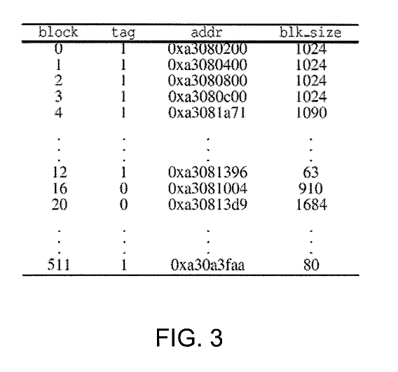

Mapping Table. Once a device is registered as a block device, the embedded system should request its blocks with their indexes within the device, regardless of the underlying data organization of the block device, e.g., compressed or not. Thus, the block device needs to provide an interface equivalent with that of a RAM device. The block device creates the illusion that blocks are linearly ordered in the device's memory area and are equal in size. To convert requests for block numbers to their actual addresses, the block device can maintain a mapping table. The mapping table can provide a direct mapping where each block is indexed by its block number, as depicted by the example mapping table shown in FIG. 3. Each entry of the table in FIG. 3 has three fields:
used records the status of the block. used=0 means the block has not been written while used=1 indicates that the block contains a swapped out page in compressed format. This field is useful for deciding whether a compressed block can be freed.
addr records the actual address of the block.
blk-size records the compressed size of the block.
It should be noted that the Linux kernel uses the first page of a swap area to persistently store information about the swap area. Accordingly, the first few blocks in the table (block 0 to block 3) in FIG. 3 store this page in an uncompressed format. Starting from page 1, the pages are used by the kernel swap daemon to store compressed pages, as reflected by the different compressed sizes.

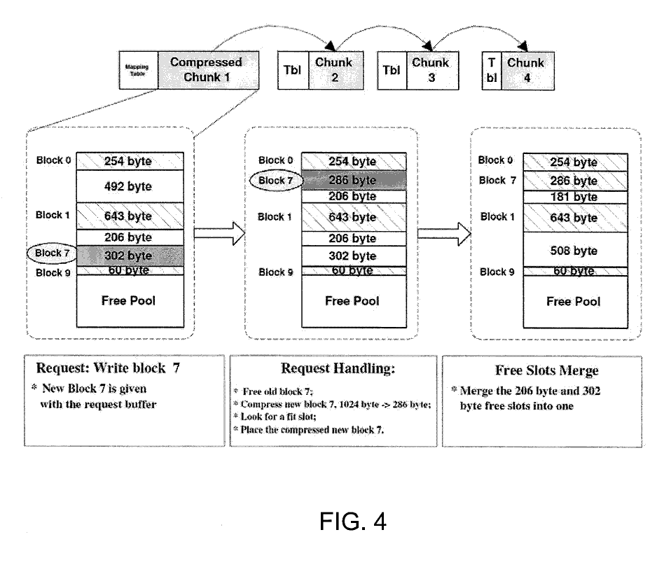

FIG. 4 illustrates the logical structure of the new block device. Similar to a regular RAM device, the block device requests a contiguous memory region in the kernel virtual memory space upon initialization. A typical RAM device would request RAM_SIZE KB and would divide the memory region in to RAM_SIZE/RAM_BLKSIZE fixed size blocks, where RAM_BLKSIZE is the block size. The new block device operates differently since its size must dynamically increase and decrease during run time to adapt to the data memory requirements of the currently-running applications. As depicted in FIG. 4, the new block device comprises several virtually contiguous memory chunks, each chunk divided into blocks with potentially different sizes. As the system memory requirement grows, the new block device requests additional memory chunks Attorney Docket No. 04040 from the kernel. These compressed memory chunks can be maintained in a linked list, as depicted in FIG. 4. Each chunk may not be divided uniformly because each compressed block may be of different sizes due to the dependence of compression ratio on the specific data in a block. When all slots in a compressed chunk are free, the block device can free the entire chunk to the system. Note, for example, in FIG. 4, as a new block 7 is provided as a request to the block device. The shaded areas represent occupied areas and the white areas represent free areas. The new block 7 compresses to a different size, e.g. 286 bytes, since the new block 7 contains different data. The old block 7 is freed, and a search is conducted for a free slot fitting the new block 7. The compressed new block 7 is placed, and the free slots are merged, as depicted in FIG. 4.

Upon initialization, the compressed area should preferably not start from a size of zero KB. A request to swap out a page is generated when physical memory has been nearly exhausted. If attempts to reserve a portion of system memory for the compressed memory area were deferred until physical memory were nearly exhausted, there would be no guarantee of receiving the requested memory. Therefore, the compressed swap area should preferably start from a small, predetermined size and increase dynamically when necessary. Note that this small initial allocation provides a caveat to the claim that the technique will not harm performance or power consumption of applications capable of running on the embedded system without compression. In fact, sets of applications that were barely capable of executing on the original embedded system might conceivably suffer a performance penalty. However, this penalty is likely negligible and would disappear for applications with data sets that are a couple of pages smaller than the available physical memory in the original embedded system.

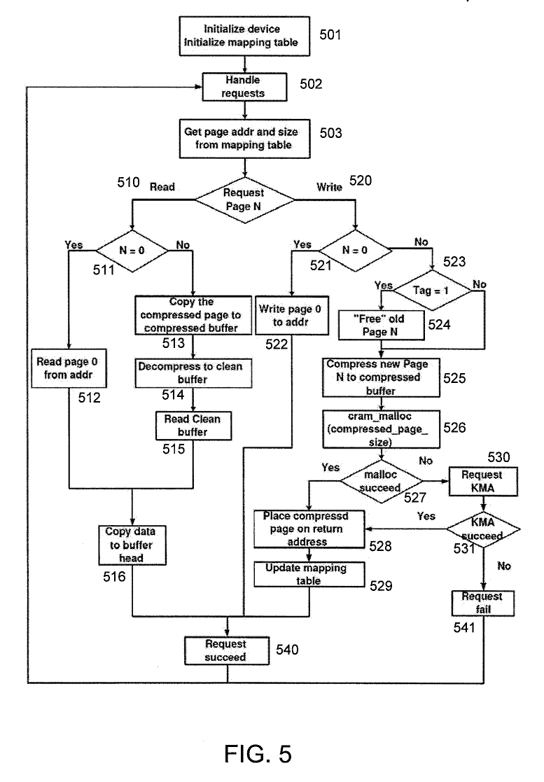

FIG. 5 is a flowchart of processing performed by the request handling procedure of the new block device. At step 501, the block device is initialized and the above-described mapping table is initialized.

At step 502, a request is received to read or write a block to the block device. Unlike a typical RAM device, a given block need not always be placed at the same fixed offset. The driver must obtain the actual address and the size of the compressed block from the mapping table at step 503. For example, when the driver receives a request to read block 7, it checks the mapping table entry tbl[7], gets the actual address from the addr field, and gets the compressed page size from the blk_size field. If the request is a read request at 510, then the driver copies the compressed page to a compressed buffer at step 513, decompresses the compressed page to a clean buffer at step 514, reads the clean buffer at step 515, and then copies the uncompressed page to the buffer head at step 516.

If the request is a write request at 521, then the handling is more complicated. For example, when the driver receives a request to write to page 7, it checks the mapping table entry tbl [7] at step 523 to determine whether the used field is 1. If so, the old page 7 may safely be freed at step 524. After this, the driver compresses the new page 7 at step 525 and requires the block device's memory allocator to allocate a block of the compressed size for new page 7 at step 526. If the memory allocator is successful at step 527, then the driver places the compressed page 7 into the memory region allocated at step 518 and proceeds to update the mapping table at step 529. On the other hand, whenever the current compressed swap area is not able to handle the write request, the driver can request more memory from the kernel at step 530. If successful at step 531, the newly allocated chunk of memory is linked to the list of existing compressed swap areas. If unsuccessful, the collective working set of active processes is too large even after compression, and the kernel must kill one or more of the processes.

As noted above, since Linux stores swap area information in the first page of a swap file, the driver can be configured to treat a read (or write) request for this page as a request for uncompressed data at steps 512 (and 522).

It should be noted that the block device can be implemented without a request queue and can handle requests as soon as they arrive. Most block devices, disk drives in particular, work most efficiently when asked to read or write contiguous regions, or blocks, of data. The kernel typically places read/write requests in a request queue for a device and then manipulates the queue to allow the driver to act asynchronously and enable merging of contiguous operations. The request queue optimization procedure is commonly referred to as coalescing or sorting. These operations have a time cost that is usually small compared with hard drive access times. Coalescing and sorting, in the context of the disclosed memory architecture, are not likely to result in improved performance, since typical memory device do not suffer from the long access times of hard disks.

It should be noted that the available physical memory of the embedded system may be reduced slightly because a small amount of memory is initially reserved for use in the compressed memory area, and applications executing immediately after other applications with data sets that did not fit into physical memory may suffer some performance degradation at start-up as the size of the compressed memory area shrinks. In practice, however, the inventors have found that these two cases had little impact on performance and energy consumption.

PBPM Compression. As noted above, any block compression technique can be utilized with the above-described architecture. Nevertheless, it would be advantageous to use a compression approach which is fast, efficient, and which better exploits the regularities of in-RAM data. Accordingly, the inventors devised the following compression approach which they refer to as “pattern-based partial match” (PBPM) compression.

In-RAM data frequently follows certain patterns. For example, pages are usually zero-filled after being allocated. Therefore, runs of zeroes are commonly encountered during memory compression. Numerical values are often small enough to be stored in 4, 8, or 16 bits, but are normally stored in fall 32-bits words. Furthermore, numerical values tend to be similar to other values in nearby locations. Likewise, pointers often point to adjacent objects in memory, or are similar to other pointers in nearby locations, e.g., several pointers may point to the same memory area. Based on experiments conducted on the contents of a typical swap file on a workstation using 32-bit size words (4 bytes), the inventors have found zero words “0000” (where “0” represents a zero byte) are the most frequent compressible pattern (38%) followed by the one byte sign-extended word “000x” (where “x” represents an arbitrary match) (9.3%) and by “0x0x” (2.8%). Other patterns that are zero-related did not represent a significant proportion of the data.

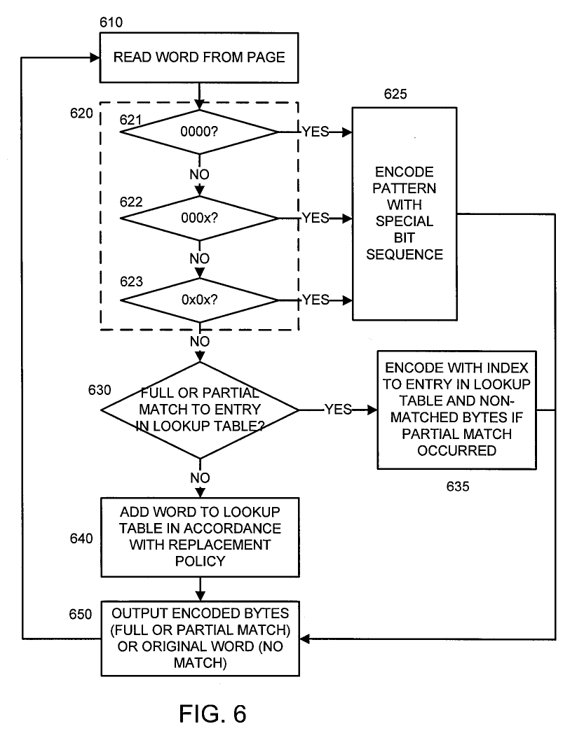

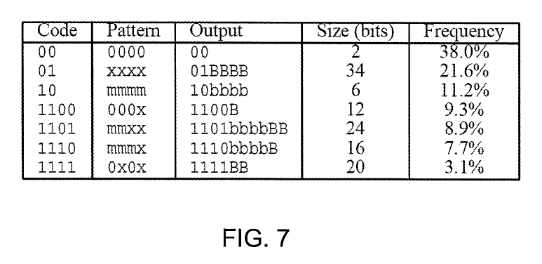

FIG. 6 is a flowchart of processing performed by the PBPM compressor in accordance with a preferred embodiment. In accordance with the example above, it is assumed that compression is being performed based on 32-bit words in a page. The compressor scans through a page and, at step 610, proceeds to process the next word from the page. At step 620, the compressor encodes very frequently-occurring patterns. For example, and as illustrated in FIG. 6, the compressor can search for the above-mentioned zero-related sequences, namely, “0000” at step 621, “000x” at step 622, and “0x0x” at step 623, where “0” represents a zero byte and “x” represents an arbitrary byte. These patterns which occur very frequently are encoded at step 625 using special bit sequences which are much shorter than the original patterns. The compressor can utilize any advantageous arbitrary encoding to represent the compressed pattern. FIG. 7 sets forth an example encoding scheme for the most frequent patterns which the inventors have found useful. FIG. 7 also reports the actual frequency of each pattern observed during the inventors' experiments on an actual swap data file.

If the word does not contain a pattern that falls into any of these frequently-occurring patterns, then the compressor proceeds to check at step 630 if the word matches an entry in a small lookup table, otherwise referred to as a dictionary. To allow fast search and update operations, it is preferable to maintain a dictionary that is hash mapped. More specifically, a portion of the word can be hash mapped to a hash table, the contents of which are random indices that are within the range of the dictionary. The inventors have found it useful to use a hash function which hashes based on the third byte in the word, which in practical situations managed to achieve decent hash quality with low computational overhead. Based on this hash function, the compressor would only need to consider four match patterns: “mmmm” (full match, where “m” represents a byte that matches with a dictionary entry), “mmmx” (highest three bytes match), “mmxx” (highest two bytes match), and “xmxx” (only the third byte matches). Note that neither the hash table nor the dictionary need be stored with the compressed data. The hash table can be static and the dictionary can be regenerated automatically during decompression. The inventors experimented with different dictionary layouts, for example, 16-entry direct mapped and 8-entry two-way associative, etc. The hash-mapped dictionary has the advantage of supporting fast search and update: only a single hashing operation and lookup are required per access. However, it has tightly limited memory, i.e., for each hash target, only the most recently observed word is remembered. With a simple direct hash-mapped dictionary, the victim to be replaced is decided based entirely on its hash target. In contrast, if a dictionary is maintained with a “move-to-front” strategy, it can support the simplest form of LRU policy: the least-recently added or access entry in the dictionary is always selected as the victim. However, searching in such a dictionary takes time linear in the dictionary size, which is significantly slower than the hash-mapped dictionary. To enjoy the benefits of both LRU replacement and speed, a 16-entry direct hash-mapped dictionary can be divided into two 8-entry direct hash-mapped dictionaries, i.e., an LRU replacement policy two-way set associative dictionary. When a search miss followed by a dictionary update occurs, the older of the two dictionary entries sharing the hash target index is replaced. It was observed that the dictionary match (including partial match) frequencies do not increase much as the dictionary size increases. While a set associative dictionary usually generates more matches than a direct hash-mapped dictionary with the same overall size, a four-way set associative dictionary appears to work no better than a two-way set associative dictionary.

FIG. 7 sets forth example patterns and coding schemes for the above-described dictionary layout. The compressor maintains a small dictionary of 16 recently seen words. The dictionary, as discussed above, preferably is maintained as a two-way set associative 16-entry dictionary. An incoming word can fully match a dictionary entry, it can also match only the highest three bytes or two bytes of a dictionary entry. Although it would be possible to consider non-byte-aligned partial matches, the inventors have experimentally determined that byte-aligned partial matches sufficient to exploit the partial similarities among in-RAM data while permitting more efficient implementation.

With reference again to FIG. 6, if word fully or partially matches a dictionary entry, the compressor at step 635 proceeds to encode the pattern with an index to the entry. If the word is a partial match, this word can be inserted into the dictionary location indicated by hashing on its third byte. Note that the victim to be replaced is decided by its age. If there is no match at all, then, at step 640, the word can be inserted into the dictionary according to the same replacement policy. The original pattern is emitted as output along with a special code added to denote that the encoding was not possible, as reflected in the example in FIG. 7. The compressor proceeds to the next word at step 650.

Correspondingly, the decompressor reads through the compressed output, decodes the format based on the patterns given in the table in FIG. 7, and adds entries to the dictionary based upon a partial match or a dictionary miss. Therefore, the dictionary can be re-constructed during compression and does not need to be stored together with the compressed data. The inventors have found the PBPM compression technique to be especially suitable for on-line memory compression because it supports extremely fast symmetric compression and has a good compression ratio.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents. As but one of many variations, it should be understood that operating systems other than Linux can be readily utilized in the context of the present invention.

What is claimed is:

1. A method of memory compression in an embedded system with an operating system supporting memory management, the method comprising the steps of:
receiving a request from the operating system to swap a page of data to a swap area;
compressing the data into a compressed page of data; and
allocating space in a compressed area of memory to which the compressed page of data is swapped where, if the compressed data does not fit within the compressed area of memory, additional memory is requested from the operating system to enlarge the compressed area of memory.

2. The method of claim 1 wherein, if there is a request from the operating system to swap the page of data back from the swap area, the compressed page of data is retrieved from the compressed area of memory, decompressed, and returned back to the operating system.

3. The method of claim 1 wherein executable code for the embedded system is stored in a compressed filesystem in memory such that the executable code need not be swapped out to the compressed area of memory.

4. The method of claim 1 wherein the compressed data is allocated to the compressed area of memory using a mapping table which tracks addresses of the compressed data and size of the compressed data.

5. The method of claim 1 wherein the additional memory for the compressed area of memory is tracked by a linked list.

6. An embedded system comprising:
a processor;
memory partitioned into a compressed area and an uncompressed working area;
a memory management module which selects pages of data to swap out of the uncompressed working area;
a compression module which compresses the pages of data into compressed pages; and
a memory allocator which allocates space in the compressed area of memory to which the compressed pages of data can be swapped where, if the compressed data do not fit within the compressed area of memory, additional memory in the memory can be requested to enlarge the compressed area of memory.

7. The embedded system of claim 8 wherein, if there is a request from the operating system to swap the page of data back from the swap area, the compressed page of data is retrieved from the compressed area of memory, decompressed, and returned back to the operating system.

8. The embedded system of claim 8 wherein executable code for the embedded system is stored in a compressed filesystem in memory such that the executable code need not be swapped out to the compressed area of memory.

9. The embedded system of claim 8 wherein the compressed data is allocated to the compressed area of memory using a mapping table which tracks addresses of the compressed data and size of the compressed data.

10. The embedded system of claim 8 wherein the additional memory for the compressed area of memory is tracked by a linked list.

11. A method of data compression comprising:
receiving a next word in a data sequence;
replacing the word with a first encoded data sequence if the word matches a frequently-occurring pattern; or
replacing the word with a second encoded data sequence if the word matches or partially matches an entry in a lookup table; or
if the word neither matches the frequently-occurring nor matches or partially matches an entry in the lookup table, then adding a third encoded data sequence to the word and storing the word in the lookup table.

12. The method of claim 11 wherein the lookup table is two-way set associative dictionary wherein entries are indexed by a hash of a portion of the word.

13. The method of claim 11 wherein the least recently accessed entry in the lookup table is selected to be replaced as the word is stored in the lookup table.

14. The method of claim 11 wherein the frequently-occurring patterns include a sequence of zero bytes.

15. The method of claim 11 wherein the frequently-occurring patterns include a sequence of zero bytes with one or more arbitrary bytes in pre-specified places where the arbitrary bytes are encoded in the first encoded data sequence.
